(19) United States
(12) Patent Application Publication
(10) Pub. No.: US 2004/0117462 A1
(43) Pub. Date: Jun. 17, 2004

(54) Client device configuration with user entry of configuration parameters

(75) Inventors: William Kress Bodin, Austin, TX (US); Michael John Burkhart, Round Rock, TX (US)

Correspondence Address: Biggers & Ohanian, PLLC, 5 Scarlet Ridge, Austin, TX, 78737, US

(73) Assignee: INTERNATIONAL BUSINESS MACHINES CORPORATION, Armonk, NY

(21) Appl. No.: 10/317,995

(22) Filed: Dec. 12, 2002

(51) Int. Cl. G06F 15/177

(52) U.S. Cl. 709/220

(57) ABSTRACT

Configuring a client device, including detecting the client device, reading a client device identifier from the client device, and requesting a configuration bundle for the client device in dependence upon the client device identifier. Embodiments include receiving a generic configuration bundle, and executing the generic configuration bundle.

### BACKGROUND OF THE INVENTION

1. Field of the Invention

The field of the invention is data processing, or, more specifically, methods, systems, and products for configuration of client devices.

2. Description of Related Art

Often when a networked client device is purchased and installed onto a network, such as a home network, the client device must be configured to operate properly. When disparate client devices using different protocols are networked together configuring these client devices often requires configuration parameters specific to the user, the network on which the client device will operate, and the client device. Current configuration techniques are often tedious and require extensive user involvement. In fact, in some complicated environments, configuration requires a truck roll with a technical installer. Many conventional configuration techniques require the user to access complicated text instructions from a home computer and wade through large amounts of technical data in order to complete the configuration process. Therefore, there is a need for an improved method of configuring a client device.

### SUMMARY OF THE INVENTION

Exemplary embodiments of the invention include methods for configuring a client device. Exemplary embodiments include detecting the client device, reading a client device identifier from the client device, and requesting a configuration bundle for the client device in dependence upon the client device identifier. Such embodiments include receiving a generic configuration bundle, and executing the generic configuration bundle.

In exemplary embodiments of the invention, detecting the connection of the client device includes polling a serial interface for the connection of a client device. In typical embodiments, executing the generic configuration bundle includes reading a configuration prompt from client device and providing the configuration prompt to a user. In such embodiments, providing the configuration prompt to a user includes creating a configuration screen for the configuration prompt. In exemplary embodiments, providing the configuration prompt to a user includes sending the configuration screen as an HTML document in an HTTP message.

In exemplary embodiments of the invention, executing the generic configuration bundle includes receiving configuration parameters from a user and writing the configuration parameters to the client device. In such embodiments, receiving configuration parameters from a user includes receiving an HTML document in an HTTP message.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating information handling architecture and various entities useful in implementing methods of configuring a client device in accordance with methods of the present invention.

FIG. 2 is a dataflow diagram illustrating an exemplary method of configuring a client device.

FIG. 3 is a dataflow diagram illustrating an exemplary method of executing a generic configuration bundle.

### DETAILED DESCRIPTION OF EXEMPLARY EMBODIMENTS

### Introduction

The present invention is described to a large extent in this specification in terms of methods for configuring a client device. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

“Field”—In this specification, the terms “field” and “data element,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.” Complex data structures that include member methods, functions, or software routines as well as data elements are referred to as “classes.” Instances of classes are referred to as “objects” or “class objects.”

“802.11” refers to a family of specifications developed by the IEEE for wireless LAN technology. 802.11 specifies an over-the-air interface between a wireless client and a base station or between two wireless clients.

“API” is an abbreviation for “application programming interface.” An API is a set of routines, protocols, and tools for building software applications.

“Bluetooth” refers to an industrial specification for a short-range radio technology for RF couplings among client devices and between client devices and resources on a LAN or other network. An administrative body called the Bluetooth Special Interest Group tests and qualifies devices as Bluetooth compliant. The Bluetooth specification consists of a ‘Foundation Core,’ which provides design specifications, and a ‘Foundation Profile,’ which provides interoperability guidelines.

“Browser” means a web browser, a communications application for locating and displaying web pages. Browsers typically comprise a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

“Coupled for data communications” means any form of data communications, wireless, 802.11b, Bluetooth, infrared, radio, internet protocols, HTTP protocols, email protocols, networked, direct connections, dedicated phone lines, dial-ups, serial connections with RS-232 (EIA232) or Universal Serial Buses, hard-wired parallel port connections, network connections according to the Power Line Protocol, and other forms of connection for data communications as will occur to those of skill in the art. Couplings for data communications include networked couplings for data communications. Examples of networks useful with various embodiments of the invention include cable networks, intranets, extranets, internets, local area networks, wide area networks, and other network arrangements as will occur to those of skill in the art. The use of any networked coupling among television channels, cable channels, video providers, telecommunications sources, and the like, is well within the scope of the present invention.

“Driver” or “device driver” means a program that controls a device. In particular, in terms of embodiments of the present invention, device drivers are directed to client devices. A device (printer, disk drive, keyboard) typically has a driver. A driver acts as translator between the device and software programs that use the device, including, for example, configuration bundles according to embodiments of the present invention. Each device has a set of specialized commands that its driver knows.

Software programs generally access devices by using generic commands. The driver, therefore, accepts generic commands from a program and then translates them into specialized commands for the device.

“GUI” abbreviates graphical user interface, a program interface that takes advantage of a computer's graphics capabilities to make computers easier to use. GUIs free users from the need to learn command languages. To improve usefulness of the computer to users, graphical user interfaces typically utilize various basic components, including ‘pointers,’ graphic symbols displayed and moved around a graphics screen to select objects and commands. Pointers are moved with pointing devices such as mice or trackballs. Commands, files, and windows are represented by small graphic images called ‘icons.’ Users can execute commands by using a pointing device to move a pointer over an icon and pressing a key or button on the pointing device. Icons are typically gathered together on a graphic display screen in an area referred to as a ‘desktop.’ Graphic display screens are divided into areas referred to as ‘windows.’ A different program or command can be run in each window. Windows can be moved around on the display screen, and their shapes and sizes can be changed. In addition to icons, most GUIs also support pop-up and pull-down menus for command execution.

“HAVi” stands for ‘Home Audio Video interoperability,’ the name of a vendor-neutral audio-video standard particularly for home entertainment environments. HAVi allows different home entertainment and communication devices (such as VCRs, televisions, stereos, security systems, and video monitors) to be networked together and controlled from one primary device, such as a PC or television. Using IEEE 1394, the ‘Firewire’ specification, as the interconnection medium, HAVi allows products from different vendors to comply with one another based on defined connection and communication protocols and APIs. Services provided by HAVi's distributed application system include an addressing scheme and message transfer, lookup for discovering resources, posting and receiving local or remote events, and streaming and controlling isochronous data streams.

“HomePlug” stands for The HomePlug Powerline Alliance. HomePlug is a not-for-profit corporation formed to provide a forum for the creation of open specifications for high speed home powerline networking products and services. The HomePlug specification is designed for delivery of Internet communications and multimedia to homes through the home power outlet using powerline networking standards.

“ID” abbreviates “identification,” meaning ‘identification code’ or identification field. It is a style of reference in this disclosure to refer to user identification codes as “User IDs.” By convention in this disclosure, the field name “UserID” is used to store a user ID.

“IEEE 1394” is an external bus standard that supports data transfer rates of up to 400 Mbps (400 million bits per second). Products supporting the 1394 standard go under different names, depending on the company. Apple, which originally developed IEEE 1394, uses the trademarked name “FireWire.” Other companies use other names, such as i.link and Lynx, to describe their 1394 products.

A single 1394 port can be used to connect up 63 external devices. In addition to high speed, 1394 also supports isochronous data—delivering data at a guaranteed rate. This makes it ideal for devices that need to transfer high levels of data in real-time, such as video.

“The Internet” is a global network connecting millions of computers utilizing the ‘internet protocol’ or ‘IP’ as the network layer of their networking protocol stacks.

The Internet is decentralized by design. Each computer on the Internet is independent. Operators for each computer on the Internet can choose which Internet services to use and which local services to make available to the global Internet community. There are a variety of ways to access the Internet. Many online services, such as America Online, offer access to some Internet services. It is also possible to gain access through a commercial Internet Service Provider (ISP). An “internet” (uncapitalized) is any network using IP as the network layer in its network protocol stack.

‘IP’ refers to the ‘internet protocol,’ a network-layer networking protocol for computer data communications.

“IP address” means an identifier for a computer or device on an IP network. Networks using the IP protocol route messages based on the IP address of the destination. The format of an IP address is a 32-bit numeric address written as four numbers separated by periods. Each number can be zero to 255. An example of an IP address is 1.160.10.240.

“ISP” means “Internet Service Provider,” a company that provides access to the Internet. For a monthly fee, an ISP provides a user identification code (often called a ‘username’), a password, and an access phone number or, for wide band services, an internet protocol address, through which to access the Internet. Equipped with proper couplings for data communications, such as a modem or cable modem, users and companies can then log on to the Internet, browse the World Wide Web, and access other Internet related services such as USENET and e-mail. In servings companies, ISPs also provide a direct connection from the companys networks to the Internet.

“JAR” is an abbreviation for ‘Java archive.’ JAR is a file format used to bundle components used by a Java applet. JAR files simplify downloading applets, because many components (.class files, images, sounds, etc.) can be packaged into a single file. JAR also supports data compression, which further decreases download times. By convention, JAR files end with a ‘.jar’ extension.

“JES” stands for Java Embedded Server. JES is a commercial implementation of OSGi that provides a framework for development, deployment, and installation of applications and services to embedded devices.

“LAN” is an abbreviation for “local area network.” A LAN is a computer network that spans a relatively small area. Many LANs are confined to a single building or group of buildings. However, one LAN can be connected to other LANs over any distance via telephone lines and radio waves. A system of LANs connected in this way is called a wide-area network (WAN). The Internet is an example of a WAN.

“OSGI” refers to the Open Services Gateway Initiative, an industry organization developing specifications for services gateways, including specifications for delivery of service bundles, software middleware providing compliant data communications and services through services gateways. The Open Services Gateway specification is a Java based application layer framework that gives service providers, network operator device makers, and appliance manufacturer's vendor neutral application and device layer APIs and functions.

“Server” in this specification refers to a computer or device comprising automated computing machinery on a network that manages resources and requests for access to resources. A “web server,” or “HTTP server,” in particular is a server that communicates with browsers by means of HTTP in order to manage and make available to networked computers documents in markup languages like HTML, digital objects, and other resources. A “DMS server,” in particular is a server that communicates with services gateways to provide service bundles to the services gateways.

“SMF” stands for “Service Management Framework™” available from IBM™. SMF is a standards-based architecture that is designed to be compliant with specifications developed by the cross-industry Open Services Gateway Initiative (OSGi). SMF is a commercial implementation of OSGi for management of network delivered applications on services gateways.

‘TCP’ refers to the ‘Transmission Control Protocol,’ a transport-layer networking protocol for networked computer data communications. TCP provides a so-called ‘reliable’ communications protocol in which a message is broken into packets which are communicated to the message's destination and reassembled into the message completely and in correct sequence. TCP is so often used with WP as its underlying network protocol layer that the two are often spoken of together as the TCP/IP protocol suite.

“TCP/IP” means the Transmission Control Protocol (TCP) and the Internet Protocol (IP) operating together. TCP/IP is a packet switching protocol suite. TCP establishes a virtual connection between a data source and a data destination. IP specifies that data will be sent from the source to the destination in packets and IP specifies the addressing scheme of the source and the destination. TCP monitors the delivery of the data and the order in which the packets are delivered.

“USB” is an abbreviation for “Universal Serial Bus.” USB is an external bus standard that supports data transfer rates of 12 Mbps. A single USB port can be used to connect up to 127 peripheral devices, such as mice, modems, and keyboards. USB also supports Plug-and-Play installation and hot plugging.

“WAP” refers to the Wireless Application Protocol, a protocol for use with handheld wireless devices. Examples of wireless devices useful with WAP include mobile phones, pagers, two-way radios, and hand-held computers. WAP supports many wireless networks, and WAP is supported by many operating systems. Operating systems specifically engineered for handheld devices include PalmOS, EPOC, Windows CE, FLEXOS, OS/9, and JavaOS. WAP devices that use displays and access the Internet run “microbrowsers.” The microbrowsers use small file sizes that can accommodate the low memory constraints of handheld devices and the low-bandwidth constraints of wireless networks.

“World Wide Web,” or more simply “the web,” refers to a system of internet protocol (“IP”) servers that support specially formatted documents, documents formatted in markup languages such as HTML (HyperText Markup Language), XML (eXtensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP (HyperText Transfer Protocol) or WAP (Wireless Access Protocol), in support of URIs and documents in markup languages, regardless of whether such servers or groups of servers are coupled to the World Wide Web as such.

### DETAILED DESCRIPTION

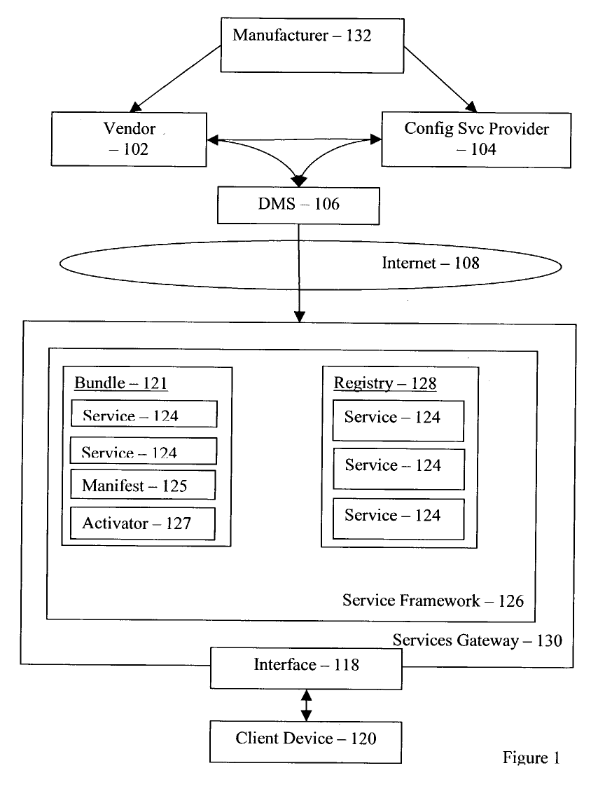

FIG. 1 is a block diagram illustrating an exemplary information handling architecture and various entities useful in implementing methods of configuring a client device in accordance with various embodiments of the present invention. The exemplary architecture of FIG. 1 includes a client device (120) to be configured. A client device (120) can be any configurable device, although in many typical embodiments of the present invention, client devices (120) are devices capable of being networked on a LAN, such as a home network, or any other network as will occur to those of skill in the art. Examples of client devices (120) to be configured include printers, a dishwasher, a DVD player, a coffeepot, or any other device that will occur to those of skill in the art.

In the exemplary architecture of FIG. 1, a client device (120) is coupled for data communication with a services gateway (130). The services gateway (130) is coupled for data communication with the internet (108). The services gateway (130) provides access for the client device (120), and any LAN on which the client device (1020 is operating, to a WAN such as the Internet.

A services gateway (130) is in some exemplary architectures an OSGi compatible services gateway (130). While exemplary embodiments of methods for configuring a client device are described in this specification using OSGi, many other applications and frameworks, will work to implement the methods of configuring a client device according to the present invention, and are therefore, also well within the scope of the present invention. Even further commercial implementations of OSGi such as JES and SMF are also useful in implementing methods of configuring client devices according to embodiments of the present invention.

OSGi Stands for ‘Open Services Gateway Initiative.’ The OSGi specification is a Java based application layer framework that provides vendor neutral application and device layer APIs and functions for various devices using arbitrary communication protocols operating in networks in homes, cars, and other environments. OSGi works with a variety of networking technologies like Ethernet, Bluetooth, the ‘Home, Audio and Video Interoperability standard’ (HAVi), IEEE 1394, Universal Serial Bus (USB), WAP, and powerline communication systems, including the Home Powerline Alliance standard known as HomePlug. The OSGi specification is available for free download from the OSGi website at www.osgi.org.

The services gateway of FIG. 1 includes a service framework (126). In many example embodiments the service framework is an OSGi service framework (126). An OSGi service framework (126) is written in Java and therefore, typically runs on a Java Virtual Machine (JVM). In OSGi, the service framework (126) of FIG. 1 is a hosting platform for running ‘services’ (124). The term ‘service’ or ‘services’ in this disclosure, depending on context, generally refers to OSGi-compliant services.

Services (124) are the main building blocks for creating applications in the OSGi. A service (124) is a group of Java classes and interfaces that implement a certain feature. The OSGi specification provides a number of standard services. For example, OSGi provides a standard HTTP service that creates a web server that can respond to requests from HTTP clients.

OSGi also provides a set of standard services called the Device Access Specification. The Device Access Specification (“DAS”) provides services to identify a device connected to the services gateway, search for a driver for that device, and install the driver for the device.

Services (124) in OSGi are packaged with other files, images, and resources that the services (124) need for execution in a ‘bundle,’ such as the bundle (121) of FIG. 1. A bundle (121) is a Java archive (JAR) file including one or more services (124), an activator class (127), and a manifest file (125). An activator class (127) is a Java class that the service framework (126) uses to start and stop a bundle. A manifest file (125) is a standard text file that describes the contents of the bundle (121).

The services framework (126) in OSGi also includes a service registry (128). The service registry (128) includes the service's name and an instance of a class that implements the service for each bundle (121) installed on the framework (126) and registered with the service registry (128). A bundle (121) may request services that are not included in the bundle (121), but are registered on the framework service registry (128). To find a service, a bundle (121) performs a query on the framework's service registry (128).

The exemplary entities of FIG. 1 also include a Device Management Server (‘DMS’) (106) coupled for data communications with the services gateway (130) though the internet (108), the World Wide Web, or any WAN. The DMS is a server specifically designed to provide, retrieve, or otherwise deploy bundles to the services gateway (130). In many typical examples, a DMS agent provides protocols for receiving requests for bundles from a gateway, authenticating the gateway, retrieving a requested bundle, and providing the requested bundle to the services gateway.

The exemplary entities of FIG. 1 include a Configuration Services Provider (‘CSP’) (104). A CSP (104) is a service provider that obtains configuration bundles for client devices and provides them to users. A user is a subscriber or customer of a CSP. A CSP receives configuration parameters from users. When a user or vendor notifies a CSP of the purchase of a client device that needs to be configured, the CSP (104) provides an associated configuration bundle for the client device. An associated configuration bundle is a configuration bundle for the client device that has within the bundle configuration parameters necessary for the configuration on the user's services gateway (130). The CSP of FIG. 1 downloads the configuration bundle to the user's services gateway through a DMS. The associated configuration bundle is executed on the services gateway to configure the client device.

The exemplary entities of FIG. I include a vendor (102). The vendor (102) sells or otherwise provides client devices (120) to the user. In examples of methods of configuring a client device, the vendor (102) also sells or otherwise provides to a user configuration bundles for the client device. In some example embodiments of the present invention, the vendor obtains the configuration bundles form a manufacturer of configuration bundles (132).

The exemplary entities of FIG. 1 also include a manufacturer (132). The manufacturer (132) of FIG. 1 is a manufacturer of configuration bundles for use with methods of configuring a client device (120) according to the present invention. The manufacturer (132) of configuration bundles for the client device is in some instances the manufacturer of the client device (120) itself. However, the manufacturer (132) of a configuration bundle may be a third-party manufacturer of configuration bundles who did not manufacture the client device.

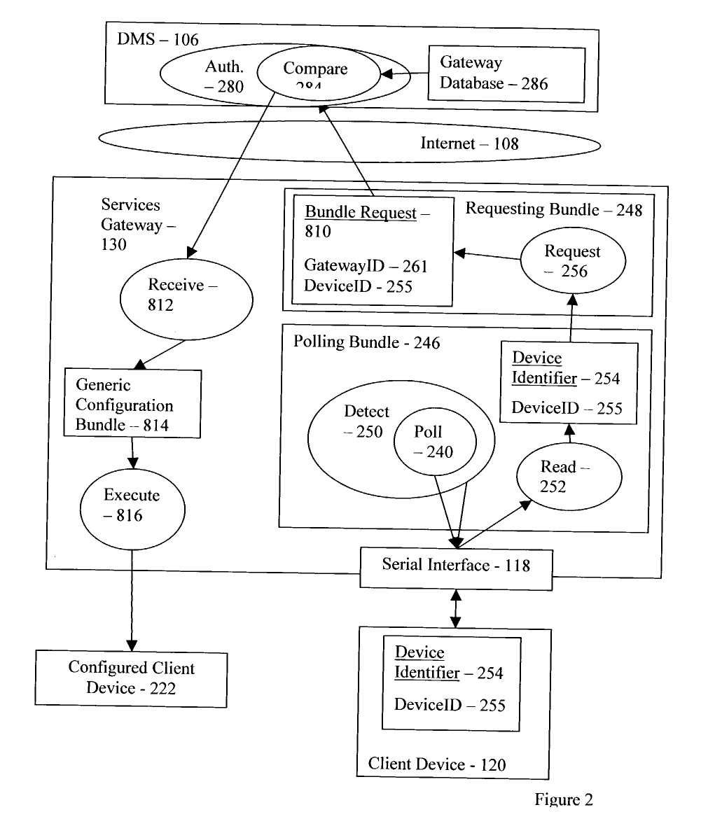

FIG. 2 is a data flow diagram illustrating an exemplary method for configuring a client device. The method of FIG. 2 includes detecting (250) the client device (120). In the method of FIG. 2, detecting (250) a client device (120) includes polling (240) a serial interface (118) of a services gateway (130) for the connection of a client device (120) to the services gateway (130). Polling (240) a serial interface (118) means periodically checking the serial interface for the connection of a client device.

In the method of FIG. 2, detecting (250) the client device (250) is carried out through a polling bundle (246). In some example embodiments, the polling bundle (246) is an OSGi bundle. An OSGi framework provides standard services in the DAS for checking for the connection of devices on the services gateway (130). In some examples, the polling bundle (246) includes specifically programmed polling services within the bundle. In alternative examples, the polling bundle (246) queries a services registry on an OSGi framework operating on the services gateway to identify standard OSGi services for checking for the connection of a device on the services gateway.

The method of FIG. 2 includes reading (252) a client device identifier (254) from the client device (120). A client device identifier (254) is any identification that sufficiently identifies the client device. Exemplary client device identifiers include manufacturer name, model name, serial number, or any other client device identifier as will occur to those of skill in the art.

The client device identifier may be represented in data by a record such as the client device identifier record (254) of FIG. 2. The client device identifier record (254) is stored in non-volatile memory on the client device (120). The client device identifier record (254) includes a deviceID field (255) representing a serial number, make and model, or any other identification of the device that will occur to those of skill in the art.

In method of FIG. 2, a polling bundle (246) carries out reading (252) a client device identifier (254) from the client device (120). In some example embodiments, the polling bundle (246) is an OSGi bundle. An OSGi framework provides standard services in a DAS for reading device identifiers from a device connected to the services gateway. In some examples according to the method of FIG. 2, a polling bundle (246) includes specifically programmed services within the bundle to read the client device identifier. In alternative examples, the polling bundle (246) queries a services registry on an OSGi framework operating on the services gateway to identify standard OSGi services for reading a client device identifier. In such embodiments, the polling bundle (246) then uses the OSGi standard services to read a client device identifier from the client device.

A DAS in an OSGi framework often also provides standard services to identify and install a driver for the client device. In embodiments that utilize such DAS services, when a polling bundle (246) detects a client device (120) and reads the client device identifier, the polling bundle queries the service registry on the service framework of the services gateway to identify standard services to obtain and install a driver to facilitate communication between the services gateway and the client device.

The method of FIG. 2 includes requesting (256) a configuration bundle for the client device (120) in dependence upon the client device identifier (254). The configuration bundle (122) includes services, computer code, and other resources for configuring the client device (120) in accordance with methods of the present invention. In some cases, the configuration bundle (122) may include a driver for the client device (120). In some examples of configuring a client device according to methods of the present invention, the configuration bundle (122) is an OSGi bundle including services for configuring the client device. The OSGi configuration bundle is executed on an OSGi services gateway to configure the client device. Because the configuration bundle (122) is designed to configure a specific client device (120), in many examples, various configuration bundles (122) have various designs according to the client device the configuration bundle is designed to configure, the network on which the client device (120) will operate, the services gateway to which the configuration bundle (122) will be deployed and executed, or any other factor that will occur to those of skill in the art.

In some examples of the present invention, requesting (256) a configuration bundle for the client device includes requesting an associated configuration bundle. An associated configuration bundle is a configuration bundle with user-provided configuration parameters contained within the bundle, such that when executed on the user's services gateway, the associated configuration bundle configures the client device without requiring the user to enter configuration parameters. Examples of user-provided configuration parameters (212) include a user's LAN mask, a user's IP default gateway address, a user's IP address, a user's LAN name, a user's DMS name, a users link type (Ethernet, Bluetooth, 802.11 ), wireless network name, wireless encryption key, or any other user-provided configuration parameters that will occur to those of skill in the art.

In some examples of methods of configuring a client device, CSPs create associated configuration bundles for users. A CSP receives user-provided configuration parameters from a user and stores the user-provided configuration parameters in a database. In many examples of methods according to the present invention, the user provides the user-provided configuration parameters one time to the CSP when the user subscribes with the CSP.

When a user subsequently purchases a client device, the CSP retrieves the user-provided configuration parameters from a database. The CSP receives vendor provided configuration parameters from a vendor, and receives a configuration bundle for the client device from a manufacturer. In many examples according to methods of the present invention, the vender provided configuration parameters include a client device identifier. A client device identifier sufficiently identifies the client device, such that the appropriate configuration bundle may be received by the CSP. Examples of client device identifiers are manufacturer's name and manufacturer's model number, a serial number, or any other client device identifier that will occur to those of skill in the art.

The CSP associates the user-provided configuration parameters and the vendor provided configuration parameters with the configuration bundle received from the manufacturer, thereby creating an associated configuration bundle. The CSP downloads the associated configuration bundle to a services gateway for a user, to a DMS for a user, or stores the associated configuration bundle until the user requests the associated configuration bundle. When the associated configuration bundle is executed on the user's services gateway, the client device is configured without requiring user entry of user-provided configuration parameters.

In other examples of methods of configuring a client device, a vendor creates an associated configuration bundle. The vendor receives user-provided configuration parameters and receives a configuration bundle for the client device the vendor sells to the user. The vendor associates the user-provided configuration parameters with configuration bundle thereby creating an associated configuration bundle for the user. The vendor downloads the associated configuration bundle to a services gateway for a user, to a DMS for a user, or stores the associated configuration bundle until the user requests the associated configuration bundle. When the associated configuration bundle is executed on the user's services gateway, the client device is configured without requiring user entry of user-provided configuration parameters.

In the method of FIG. 2, requesting (256) a configuration bundle for the client device includes requesting an associated configuration bundle for the client device from a DMS. The DMS is a server specifically designed to provide bundles to the services gateway (130). Alternatively, requesting (256) a configuration bundle for the client device includes requesting an associated configuration bundle from a vendor, manufacturer, or CSP.

A request for an associated configuration bundle is represented in a data as a record such as the bundle request record (810) of FIG. 2. The bundle request record (810) includes a deviceID field (255) identifying the client device to be configured. The bundle request record (810) also includes a gatewayID field (261) identifying the gateway requesting the associated configuration bundle. In some examples, the gatewayID and the DeviceID together uniquely identify the associated configuration bundle for the device. In other example, the bundle request record includes a userID identifying the user.

Requesting an associated configuration, in many embodiments of the present invention, is carried out by a requesting bundle, such as the requesting bundle (242) of FIG. 2. In some exemplary embodiments according to the present invention, the requesting bundle (242) is an OSGi bundle including services capable of sending a request for an associated configuration bundle to a DMS. The OSGi framework provides a standard HTTP service. In some examples, a requesting bundle (242) sends a bundle request to the DMS as a HTML document in an HTTP message.

The method of FIG. 2 includes authenticating (280) the services gateway (130). Authenticating the gateway can be carried out, for example, by comparing (284) the gatewayID field (261) of the bundle request record (810) with a gateway database (286). In the method of FIG. 2, authenticating (280) the services gateway (130) is carried out by a DMS. The DMS authenticates the services gateway by comparing the services gatewayID (261) with a database of gateway identifiers registered with the DMS. When the services gateway is authenticated, the DMS attempts to identify an associated configuration bundle for the client device stored on the DMS, or attempts to retrieve an associated configuration bundle from a CSP or vendor.

The method of FIG. 2 includes receiving (812) a generic configuration bundle (814). A generic configuration bundle (814) is a configuration bundle for carrying out methods of configuring a client device in accordance with the present invention when an associated configuration bundle is not available either because the associated configuration bundle does not exist, or the services gateway does not have access to the associated configuration bundle through a DMS, CSP, vendor, or manufacturer. The generic configuration bundle (814) includes services and other resources to facilitate the user's entry of user-provided configuration parameters to configure the client device (120). In some examples of the method of FIG. 2, the generic configuration bundle (814) includes a driver for the client device to facilitate communication between the services gateway (130) and the client device (120).

The method of FIG. 2 includes executing (816) the generic configuration bundle (814). In many cases, the generic configuration bundle (814) is executed when the client device (120) is detected on the services gateway (130). In other examples, executing (816) the generic configuration bundle (814) includes receiving an instruction from the user to execute the generic configuration bundle (814). Using a web browser installed on a computer connected to the services gateway, a user can through a series of instruction screens instruct the services gateway to execute the generic configuration bundle. In many embodiments, a services gateway according to the present invention has installed directly upon it no user interface hardware, no terminal screen, no keyboard, no mouse, although such services gateways do often support HTTP interfaces to services on the gateway. In such embodiments, a user can access HTTP screens on the gateway by logging on to a browser on a personal computer or other client device that does support user interface hardware and is coupled to the gateway through a LAN and directing the browser to the services gateway's IP address on the LAN.

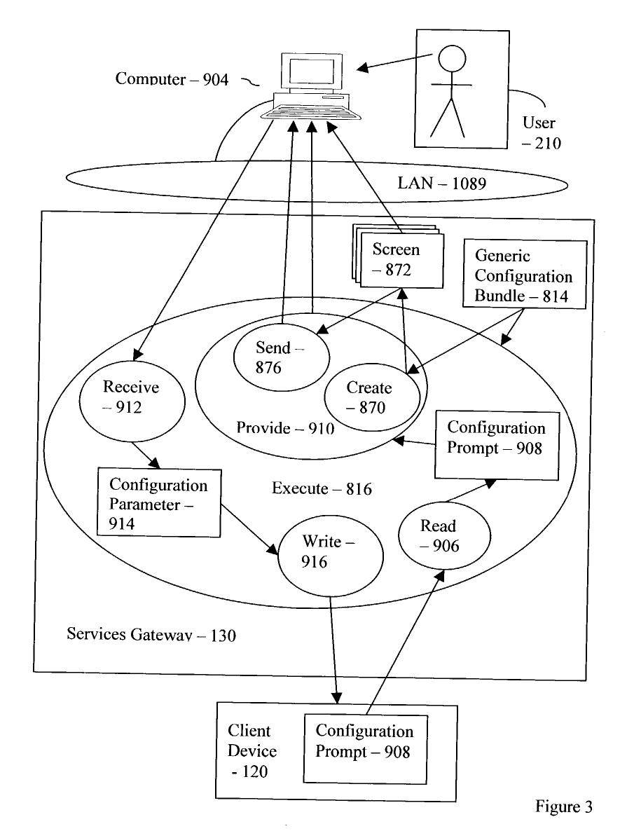

FIG. 3 is a data flow diagram illustrating an exemplary method of executing (816) a generic configuration bundle (814). In the method of FIG. 3 executing (816) a generic configuration bundle (814) includes reading (906) a configuration prompt (908) from a client device (120). In method of FIG. 3, a configuration prompt (908) is stored in non-volatile memory on the client device (120). The configuration prompt (908) includes prompting text for display to a user that identifies the user-provided configuration parameters necessary to configure the client device. Examples of user-provided configuration parameters include a user's LAN mask, a user's IP default gateway address, a user's IP address, a user's LAN name, a user's DMS name, a users link type (Ethernet, Bluetooth, 802.11 ), wireless network name, wireless encryption key, or any other user-provided configuration parameters that will occur to those of skill in the art.

In some examples of the method of FIG. 3, reading (906) a configuration prompt (908) from a client device (120) is carried out by services in an OSGi framework called by the generic configuration bundle (814). The generic configuration bundle may call services from within the generic configuration bundle that are programmed specifically to read the configuration prompt from the client device. In alternative examples of the method of FIG. 3, the generic configuration bundle queries a services registry on the framework to locate a service or set of services capable of reading the configuration prompt from the client device.

The method of FIG. 3 includes providing (910) the configuration prompt (908) to a user (210). In some embodiments, providing the configuration prompt to the user is carried out by providing the prompt in text at a command line prompt such as the one provided by the command “cmd.exe” in modern versions of Microsoft Windows or any other text based prompt that will occur to those of skill in the art. In many embodiments, a services gateway according to the present invention has installed directly upon it no user interface hardware, such as a terminal screen, keyboard, or mouse. In such embodiments, providing the prompt to a user includes communicating the prompt across a LAN to another client device such as a personal computer or workstation having connected to it user interface hardware such as a terminal screen, keyboard, mouse, and so on. That is, in many example embodiments of the method of FIG. 3, providing (910) the configuration prompt (908) to a user includes writing the configuration prompt (908) to a terminal screen on a computer (904) connected to the services gateway (130) across a LAN (109).

In many examples of the method of FIG. 3, configuration prompts (908) stored on the client device (120) are text only prompts. As text only, the configuration prompts (908) are, in many cases, unfriendly or complicated to users unfamiliar with configuring the client device (120). In the method of FIG. 3, providing (910) the configuration prompt (908) to a user includes creating (870) a configuration screen (872) for the configuration prompt (908) read from the client device (120). The configuration screen (872) of the method of FIG. 3 is a user-friendly GUI data entry screen designed to facilitate the user's entry of user-provided configuration parameters. In many examples of the method of FIG. 3, multiple configuration screens (872) are created to walk the user through the configuration process. In some examples of the method of FIG. 3, creating (972) the configuration screens (872) includes creating the configuration screen as an HTML document and sending (876) the configuration prompt (908) to the user as an HTML document in an HTTP message.

In many embodiments where the services gateway has no user interface hardware, the services gateway does support HTTP. In such embodiments, a user can access the HTML configuration screens (872) sent to the user as HTTP messages by logging on to a browser on a personal computer (904) as or other client device that does support user interface hardware and is coupled to the services gateway through a LAN and directing the browser to the services gateway's IP address on the LAN.

In some examples of the method of FIG. 3, creating (870) the configuration screens is carried out by OSGi services contained within the generic configuration bundle (814). In alternative examples, the generic configuration bundle (814) queries a services registry on the framework to identify services useful in creating configuration screens (872).

The method of FIG. 3 also includes receiving (912) configuration parameters (914) from a user (210). In the method of FIG. 3, receiving (912) configuration parameters (914) from a user (210) comprises receiving an HTML document in an HTTP message. Using a web browser installed on a computer connected through a LAN to the services gateway, a user accesses the configuration screen (872) provided to the user and enters the user-provided configuration parameters. Examples of user-provided configuration parameters include a user's LAN mask, a user's IP default gateway address, a user's IP address, a user's LAN name, a user's DMS name, a users link type (Ethernet, Bluetooth, 802.11 ), wireless network name, wireless encryption key, or any other user-provided configuration parameters that will occur to those of skill in the art.

The method of FIG. 3 includes writing (916) the configuration parameters (914) to the client device (120). In some examples of the method of FIG. 3, writing (916) the configuration parameters to the client device is carried out by services in an OSGi framework. That is, in such embodiments, the generic configuration bundle can query a services registry in an OSGi framework to identify a service or set of services capable of writing the user-provided configuration parameters to the client device.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for configuring a client device, the method comprising the steps of:
detecting the client device;
reading a client device identifier from the client device;
requesting a configuration bundle for the client device in dependence upon the client device identifier;
receiving a generic configuration bundle; and
executing the generic configuration bundle.

2. The method of claim 1 wherein detecting the connection of the client device comprises polling a serial interface for the connection of a client device.

3. The method of claim 1 wherein executing the generic configuration bundle comprises reading a configuration prompt from client device and providing the configuration prompt to a user.

4. The method of claim 3, wherein providing the configuration prompt to a user comprises creating a configuration screen for the configuration prompt.

5. The method of claim 4 wherein providing the configuration prompt to a user comprises sending the configuration screen as an HTML document in an HTTP message.

6. The method of claim 1, wherein executing the generic configuration bundle comprises receiving configuration parameters from a user and writing the configuration parameters to the client device.

7. The method of claim 6 wherein receiving configuration parameters from a user comprises receiving an HTML document in an HTTP message.

8. A system for configuring a client device, the system comprising:
means for detecting the client device;
means for reading a client device identifier from the client device;
means for requesting a configuration bundle for the client device in dependence upon the client device identifier;
means for receiving a generic configuration bundle; and
means for executing the generic configuration bundle.

9. The system of claim 8 wherein means for detecting the connection of the client device comprises means for polling a serial interface for the connection of a client device.

10. The system of claim 8 wherein means for executing the generic configuration bundle comprises means for reading a configuration prompt from client device and means for providing the configuration prompt to a user.

11. The system of claim 10, wherein means for providing the configuration prompt to a user comprises means for creating a configuration screen for the configuration prompt.

12. The system of claim 11, wherein means for providing the configuration prompt to a user comprises means for sending the configuration screen as an HTML document in an HTTP message.

13. The system of claim 8, wherein means for executing the generic configuration bundle comprises means for receiving configuration parameters from a user and means for writing the configuration parameters to the client device.

14. The system of claim 13, wherein means for receiving configuration parameters from a user comprises means for receiving an HTML document in an HTTP message.

15. A computer program product for configuring a client device, the computer program product comprising:
a recording medium;
means, recorded on the recording medium, for detecting the client device;
means, recorded on the recording medium, for reading a client device identifier from the client device;
means, recorded on the recording medium, for requesting a configuration bundle for the client device in dependence upon the client device identifier;
means, recorded on the recording medium, for receiving a generic configuration bundle; and
means, recorded on the recording medium, for executing the generic configuration bundle.

16. The computer program product of claim 15 wherein means, recorded on the recording medium, for detecting the connection of the client device comprises means, recorded on the recording medium, for polling a serial interface for the connection of a client device.

17. The computer program product of claim 15 wherein means, recorded on the recording medium, for executing the generic configuration bundle comprises means, recorded on the recording medium, for reading a configuration prompt from client device and means, recorded on the recording medium, for providing the configuration prompt to a user.

18. The computer program product of claim 17, wherein means, recorded on the recording medium, for providing the configuration prompt to a user comprises means, recorded on the recording medium, for creating a configuration screen for the configuration prompt.

19. The computer program product of claim 18 wherein means, recorded on the recording medium, for providing the configuration prompt to a user comprises means, recorded on the recording medium, for sending the configuration screen as an HTML document in an HTTP message.

20. The computer program product of claim 15, wherein means, recorded on the recording medium, for executing the generic configuration bundle comprises means, recorded on the recording medium, for receiving configuration parameters from a user and means, recorded on the recording medium, for writing the configuration parameters to the client device.

21. The computer program product of claim 20 wherein means, recorded on the recording medium, for receiving configuration parameters from a user comprises means, recorded on the recording medium, for receiving an HTML document in an HTTP message.
